(19) United States
(12) Patent Application Publication
(10) Pub. No.: US 2007/0248446 A1
(43) Pub. Date: Oct. 25, 2007

(54) MULTIFUNCTION MANIPULATOR FOR PALLETIZING BAGGED MATERIAL

(76) Inventors: Jay R. Wildner, Madison, WI (US); Terry Heintz, Madison, WI (US)

Correspondence Address: Intellectual Property Department;DEWITT ROSS & STEVENS S.C., Suite 401, 8000 Excelsior Drive, Madison, WI, 53171-1914, US

(21) Appl. No.: 11/740,110

(22) Filed: Apr. 25, 2007

Related U.S. Application Data
(60) Provisional application No. 60/794,655, filed on Apr. 25, 2006.

(51) Int. Cl. B65G 57/00

(52) U.S. Cl. 414/788

(57) ABSTRACT

An apparatus connectable to a robotic arm for selecting, positioning, and loading a pallet for use in manufacturing and warehouses. The apparatus being made of a frame with opposing pallet gripping arms with hooks to engage and transport a pallet. The frame also having a suction assembly, which can select and transport a top loading sheet for placement on top of a pallet. The frame further comprising a carriage sub-assembly which aligns, stabilizes, and secures articles, including different sized and amorphous bagged materials. The frame further comprising opposing bag gripping arms, which lift and carry the articles to the pre-positioned pallet and stack them.

### REFERENCE TO RELATED APPLICATION

The application claims priority to U.S. Provisional Application entitled “Multi-function Manipulator for Palletizing Bagged Material,” Ser. No. 60/794,655, filed Apr. 25, 2006, which is incorporated herein by reference in its entirety.

### FIELD OF THE INVENTION

This invention relates generally to materials handling apparatus, and more specifically to a machine designed to arrange and prepare a pallet and to stack articles having a non-rigid form on the pallet.

### DESCRIPTION OF THE PRIOR ART

A host of automated devices for moving, stacking, indexing, palletizing, or otherwise manipulating materials are described in the patent literature. See, for example, U.S. Pat. Nos. 7,137,234; 6,658,816; 6,524,058; 6,238,173; 6,000,904; 5,984,621; 5,848,867; 5,807,065; 5,791,867; 5,695,313; 5,690,464; 5,421,698; 5,411,304; 5,310,306; 5,190,430; 5,141,274; 5,088,877; 5,088,783; 5,066,189; 5,030,055; 4,836,731; 4,674,238; 4,592,692; 4,082,194; 4,055,261; 4,005,782; 3,884,363; and 3,697,112.

None of these devices, however, are adept at palletizing diverse materials, such as the pallets themselves, sheet materials, and especially bagged materials. A vast array of goods are transported in bags for ultimate sale to the consumer, ranging from food destined for human and animal consumption (e.g., grains, flour, sugar, formulated livestock feeds and feed additives, pet food, etc.), agricultural products (e.g., seeds for planting, fertilizer, mulch, herbicides, pesticides, etc.), construction materials (plaster, concrete mix, sand etc.), and consumer products such as kitty litter, water-softener salt, and the like. To transport these goods from the manufacturer to the distributor and/or retail seller, the bagged material is palletized for ease of loading and unloading the shipment.

Bagged materials, however, present distinct challenges for automated handling equipment due to the flexible nature of the packaging material from which the bags are fabricated and the ability of the contents of each bag to shift. Thus, for example, a manufacturer may sell its powdered goods in two different quantities: 100 lb. bags and 50 lb. bags. It is often the case, however, that the same bag is used for both sizes; the 100 lb. bag is simply filled twice as full as the 50 lb bag. This scenario presents troubles for conventional automated handling equipment because the 50 lb bag, while having roughly the same outer dimensions as the 100 lb bag, is far more flaccid that the 100 lb. bag.

Often, customers would be required to purchase different machines to palletize different sized bulk loads. Additional machines were also required to position and prepare empty pallets. These machines require manual placement of top sheets. Recently, fully automatic palletizers were introduced that integrated the manual placement of top sheets as an automatic function of the machine. See U.S. Pat. Nos. 5,672,045 and 6,658,816.

These prior art approaches use separate, distinct, and complex mechanical devices to perform the operations of picking and positioning the empty pallet, feeding the individual top sheets, and stacking the bulk articles onto the pallets. The present invention eliminates the need for multiple machines to prepare a pallet and stack different sized bags on the pallet.

### SUMMARY OF THE INVENTION

The present invention is directed to a multi-function manipulator for palletizing a bulk load comprising a frame dimensioned with a top, bottom, front, rear, left side, and a right side, pallet gripping arms, opposingly affixed to the frame, an article grasp, a pressure sensitive carriage assembly, and a suction assembly; wherein the article grasper further comprises a plurality of opposing grasper arms which are movably mounted on the bottom of the frame and dimensioned and configured to selectively engage and disengage a work-piece; wherein the pressure sensitive carriage assembly is mounted between the plurality of opposing grasper arms on the bottom of the base frame; and wherein the suction assembly is dimensioned and configured for transporting a work-piece.

The present invention is further directed to a multifunction manipulator for palletizing a bulk load comprising a frame dimension with a top, a bottom, a front, a rear, a left side, and a right side, pallet gripping arms opposingly affixed to the frame, an article grasper further comprising a plurality of opposing grasper arms movably mounted on the bottom of the frame and dimensioned and configured to selectively engage and disengage a work-piece, a pressure sensitive carriage assembly mounted between the plurality of opposing grasper arms on the bottom of the frame, and a suction assembly mounted on a side of the frame wherein the assembly is dimensioned and configured for transporting a work-piece; further comprising at least one cylinder connected to the frame dimensioned and configured to operate the pallet gripping arms, the article grasper, the pressure sensitive carriage assembly, and the suction assembly; further comprising a linkage rotationally attached to the pallet gripping arms, wherein the linkage is dimensioned and configured so that each pallet gripping arm moves in conjunction with an opposing pallet gripping arm; further comprising a linkage attached to the frame wherein the linkage is dimensioned and configured to releasably attach the frame to a robotic arm.

The invention is a manipulator that is capable of handling and palletizing both bagged materials and sheet materials. The manipulator is, for example, capable of stacking the pallets themselves (so that the pallets may be easily transported). The manipulator is also capable of palletizing any type of sheet material, from paper, to card board, to tiles, to wood products, dry wall products, sheet insulation, and the like.

In particular, the device is novel in that it includes a cooperating, three-function assembly that employs (1) arms for gripping pallets; (2) a vacuum-implemented array for gripping sheet material; and (3) a pair of pressure-sensitive carriage plates (that can move both independently and in tandem). The pressure-sensitive carriage plates work in conjunction with the tines to ensure that the bagged material is gripped sufficiently firmly to move the load with authority, but not so firmly as to damage the bag itself. The carriage plates also function as a chute that directs the bag to the desired location when the plates release their grip on the bag being moved.

This aspect of the invention is important because, unlike rigid packaging, where each “building block” is inherently stiff and retains a fixed shape, a bag can and will assume odd, irregular shapes. This adds a level of complexity when designing a machine to stack bags into an ordered array, such as when palletizing them. By forcing the bags to retain, if only for a moment, a slightly compressed profile, and then dropping the bag without any pitch, yaw, or roll, the bags are made to maintain a uniform geometric profile from bag-to-bag. This allows the bags to be palletized in ordered arrays that are stable and can be transported without worries that the stacked bags will collapse.

Thus, in a more specific version, the invention is directed to an apparatus for palletizing a load of bagged material. The apparatus comprises a frame having a top, a bottom, a front, a rear, a left side, and a right side. Pallet gripping arms are opposingly affixed to the frame and dimensioned and configured to reversibly engage a pallet. The pallet gripping arms are movable between a disengaged position, an engaged position, and a stowed position. The pallet gripping arms are pivotally movable between these three positions. When in the stowed position, the pallet gripping arms are substantially parallel with the frame. When in the engaged position, the pallet gripping arms are substantially perpendicular to the frame and positioned to grasp a pallet therebetween. When in the disengaged position, the pallet gripping arms are positioned to release a pallet (or to be disposed outside the perimeter of a pallet just prior to engaging it). Each of the pallet gripping arms further comprises a gripping portion dimensioned and configured to reversibly engage the pallet. The device also includes an article grasper comprising a pair of opposing grasper arms movably mounted to the bottom of the frame and dimensioned and configured to selectively engage and disengage a bag work piece. The grasper arms are movable between an open and a closed position. A pressure-sensitive carriage assembly is mounted between the opposing grasper arms. The pressure-sensitive carriage assembly comprises first and second horizontal guide plates positioned substantially parallel to one another. Opposing pressure-sensitive switches are attached to the first and second horizontal guide plates. These pressure-sensitive switches are dimensioned and configured to halt inward motion of the guide plates when the bag work piece is centered between the guide plates. Thus, the switches function to ensure that the bag to be manipulated is properly oriented so that can be securely grasped by the device. A suction assembly is mounted on a side of the frame. The suction assembly is dimensioned and configured for transporting a sheet work piece, such as a tier sheet, top sheet, bottom sheet, and the like.

The objects and advantages of the invention will appear more fully from the following detailed description of the preferred embodiment of the invention made in conjunction with the accompanying drawings.

### BRIEF DESCRIPTION OF THE DRAWINGS

FIG. 1 is a front elevation of a preferred embodiment of the manipulator.

FIG. 2 is a top plan view of the manipulator in FIG. 1.

FIG. 3 is a left elevation of the manipulator in FIG. 1.

FIG. 4 is a top plan view of the linkage sub-assembly for the carriage plate assembly.

FIG. 5 is a front elevation of the carriage plate assembly.

FIG. 6 is a side elevation of the bag gripper assembly

FIG. 7 is a front elevation of the bag gripper assembly and the sliding brake sub-assembly.

FIG. 8a is a bottom plan view of the robotic arm linkage.

FIG. 8b is a side elevation of the robotic arm linkage.

FIG. 8c is a top plan view of the robotic arm linkage.

FIG. 9a is a top plan view of the tine assembly.

FIG. 9b is a side elevation of the tine assembly.

FIG. 9c is a front elevation of the tine weldment sub-assembly.

### DETAILED DESCRIPTION

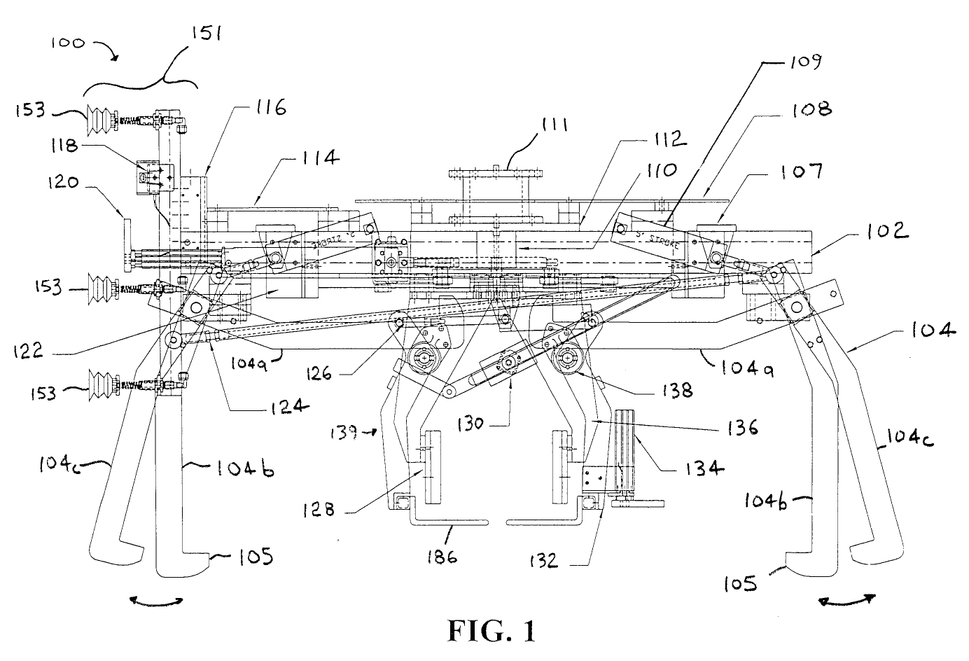

The invention is a multifunction manipulator 100 useful for placing bulk objects on a pallet. The preferred embodiment of the invention can be attached to an articulated robotic arm (conventional, not shown), which moves the manipulator 100 around a manufacturing floor. In the preferred embodiment, the manipulator 100 has four pallet gripping arms 104 each positioned at the corners of the frame 102. Each pallet gripping arm 104 opposes another pallet gripping arm. Each pallet gripping arm 104 is movable from a disengaged position to an engaged position and to a stowed position. In the disengaged position, each pallet gripping arm is positioned substantially perpendicular to the frame. As shown in FIG. 1, in the stowed position 104a, each gripping arm 104 is folded in parallel with the frame 102, as well as the other pallet gripping arms 104. Opposite the point of connection 103 to the frame 102, each pallet gripping arm 104 has a pallet hook 105. When the manipulator 100 is placed over a pallet, the pallet gripping arms 104 are positioned outside the perimeter of the pallet. The pallet gripping arms are urged from the disengaged position 104c to the engaged position 104b, thereby securing the pallet hooks 105 to the pallet. At this point the robotic arm and manipulator 100 can move the pallet securely to a desired position, at which time the gripping arms 104 are urged into the open position and the pallet is released. In order to begin stacking bagged articles, the pallet gripping arms 104 are folded out of the way to the fully enclosed position, substantially parallel to the frame 102.

With the pallet in place, the manipulator 100 places a top sheet onto the pallet through the use of the vacuum sub-assembly 151. The vacuum sub-assembly 151 includes a plurality of flexible, accordion-like suction cups 153 that serve to releasably grip sheet material via reduced air-pressure. The suction cups 153 are positioned on the side of the frame with the opening of the suction cups 153 oriented substantially parallel to the frame 102. In operation, the manipulator 100 is rotated into a position parallel with the surface of the sheet material (not shown) to be manipulated, and the suction cups 153 are then brought into contact with the surface of the sheet material. A negative pressure is created by a vacuum pump (not shown), which causes the suction cups to grip the sheet material very tightly, such that the entire manipulator 100, with the sheet material attached, may then be moved (via a robotic arm, not shown). When the sheet material is in the desired location, the vacuum within the suction cups is released, thereby releasing the sheet material from the manipulator 100.

The robotic arm then positions the manipulator 100 over a conveyor belt to begin stacking bags. The robotic arm places the manipulator 100 in position over a conveyor belt, which transports bagged material. The manipulator 100 has a carriage assembly 121 with two parallel guide-plates 128. The guide-plates 128 are designed with pressure-sensitive switches which provide feedback to a controller device. When a bag of material has reached a predetermined point on a conveyor belt between the two guide-plates 128 of the carriage assembly 121, the guide-plates are urged together. The guide-plates 128 serve two functions. The first is orienting the bag in a proper position. For example, if the bag is slightly askew coming down the conveyor belt, the guide-plates 128 will align the bag so that it is squarely between the guide-plates. This action helps create a more regular stacking of the bags upon the pallet. The second action is compressing the material contained within the bag. By slightly compressing the bag, the guide-plates 128 level the contents of the bag, thereby making all of the bags more uniform in shape. After the bag is aligned and secured by the carriage assembly 121, the bag grasper 139 engages the bag.

In the preferred embodiment, the bag grasper 139 is comprised of two opposing grasper arms 173. The two grasper arms 173 are movably mounted to the bottom of the frame 102. Each individual grasper arm 173 is secured laterally to a guide-plate 128 of the carriage assembly. Thus, the entire carriage assembly 121 is attached to the frame 102 between the two bag grasper arms 173. Opposite the pivot point 103, each bag grasper arm 173 has a plurality of tines 186 attached perpendicularly to the grasper arm. The bag grasper arms 173 are movable between an open position and a closed position. In the closed position, the bag grasper arm 173 is positioned substantially perpendicular to the frame 102 of the manipulator 100. In the open position, the bag grasper arm 173 is positioned substantially parallel to the frame 102. The tines 186 are sufficiently long to support a bag or other object between them when they are in the closed position. In operation, once the carriage assembly 121 has aligned and secured the bag, the bag grasper arms 173 move from an open position to a closed position. In the closed position, the tines 186 affixed to the bag grasper arms slide underneath both the carriage assembly 121 and underneath the bag. Because there are two opposing bag grasper arms 173, the bag is supported by tines 186 on either side.

The opposing bag grasper arms 173 move substantially in tandem with one another, which means the arms move from the open to closed position simultaneously and reverse positions simultaneously. After the bag gripper arms 173 have moved into the closed position and the tines are sufficiently supporting the bagged article, the robotic arm lifts the entire manipulator 100 with the bag secured between the gripper arms 173 and positions it over the pre-positioned pallet. The robotic arm arranges the bag gripper 139 at an appropriate position over the pallet, several inches above the pallet. The bag gripper arms 173 quickly move to the open position and drop the bag into the pre-determined position on the pallet. Dropping the bag from several inches above the position causes the bag to vertically compress and settle into a secure position. This process is repeated until the pallet is stacked to a pre-determined height in a pre-determined pattern.

Reference will now be made to the attached drawings, where the same reference numerals are used throughout the various views.

As shown in FIG. 1 the manipulator 100 includes a frame assembly 102. The frame assembly 102 is the support structure for the manipulator and is fabricated from extruded aluminum. Extruded aluminum is preferred because it supplies the required mechanical strength and rigidity, while being extremely lightweight. Other suitable materials may also be used for the frame, including other metals and alloys (e.g., steel), composite materials, or suitably rigid polymeric materials. Pallet gripper arms 104 are movably mounted to the frame assembly 102. In the preferred embodiment of the manipulator 100, two sets of two pallet gripper arms 104 are opposingly attached 103 to the perimeter of the frame assembly 102. In this configuration, the pallet hooks 105 on each pallet gripper arm 104 oppose each other. The pallet hooks 105 rotate in the direction shown in the arrows and are urged either to open or close by the action of pistons 107 and cylinders 109. The cylinders 109 are attached to the frame assembly 102 at the cylinder mount 106. The mechanical sub-operations, attached to the frame assembly 102, are generally protected by the manipulator frame cover 108. A robot arm linkage 111 is affixed to the top of the frame assembly 102 via the robot arm linkage attachment plate 112. The robot arm linkage attachment plate 112 is secured to the frame assembly 102 by the linkage center support block 110. Each set of opposing pallet gripping arms 104 are joined by a pallet arm linkage rod and spacer 124. The piston 107 urges one of the opposing pallet gripping arms 104 and the linkage rod 124 urges the opposing pallet gripper arm 104 to move in the same direction, either in the open or closed position. The structural rigidity of the manipulator 100 is further increased by a lateral frame plate 114. The lateral frame plate 114 also protects mechanisms on the left side of the manipulator 100.

In the preferred embodiment, the mechanical movements of the manipulator 100 are operated by pneumatic cylinders attached to the frame assembly 102, for example the gripper arm cylinder 109. The pneumatic power source (not shown) provides positive and negative airflow to the manipulator 100 via pneumatic tubes (not shown). The air manifold (not shown) is attached to the manifold mounting bracket 116 from which the pneumatic tubes (not shown) can feed the various subassemblies.

The suction subassembly 153 is preferably on the left side of the manipulator 100. The suction subassembly 151 is further comprised of a plurality of suction cups 153. When the manipulator 100 is lowered onto a stack of top sheets (not shown) a proximity indicator (not shown) is used to control the speed and location of the manipulator 100. The chosen proximity indicator is attached to the manipulator 100 in the proximity indicator bracket 118. Typical examples of proximity indicators use infrared technology. The carriage of the subassembly 121 and the bag gripper subassembly 139 are movably affixed to the bottom of the manipulator 100. The carriage subassembly 121 includes two opposing carriage plates with spring actuators 128. The carriage plates 128 are rotatably movable from an open position to a closed position. In the open position, each carriage plate 128 abuts a carriage stop end plate 122. The carriage plates 128 are urged into a closed position, which is substantially perpendicular to the frame assembly 102, by pneumatic pressure. Although pneumatic pressure is preferred, other examples of power include hydraulic or electric motors. The carriage plates 128 are attached to a carriage plate weldment 136 which is pivotally attached to the frame assembly 102.

The bag gripper subassembly 139 is comprised of two tine-support weldments 132 pivotally attached to the frame assembly 102 by a bag gripper bearing 138. The two tine-support weldments 132 oppose one another and are attached the frame assembly 102 slightly outside the carriage subassembly 121. Thus, the two opposing carriage plate weldments are positioned between the two opposing tine-support weldments 132. The two tine-support weldments 132 move between and open position (substantially parallel with the frame assembly 102 and a closed position (substantially perpendicular to the frame assembly 102). The opposing tine-support weldments 132 move substantially in tandem with the addition of a sliding brake subassembly 130. Each tine-support weldment 132 also includes a clevis pin modification 126 which facilitates the tandem movement. Each tine-support weldment 132 has a plurality of tines 186, which in the closed position are substantially parallel to the frame assembly 102. A pneumatic cylinder is attached to the bag gripper guided search cylinder bracket 134. Furthermore, a pneumatic cylinder for the pallet gripper arms is connected to the pallet guided search cylinder bracket 120.

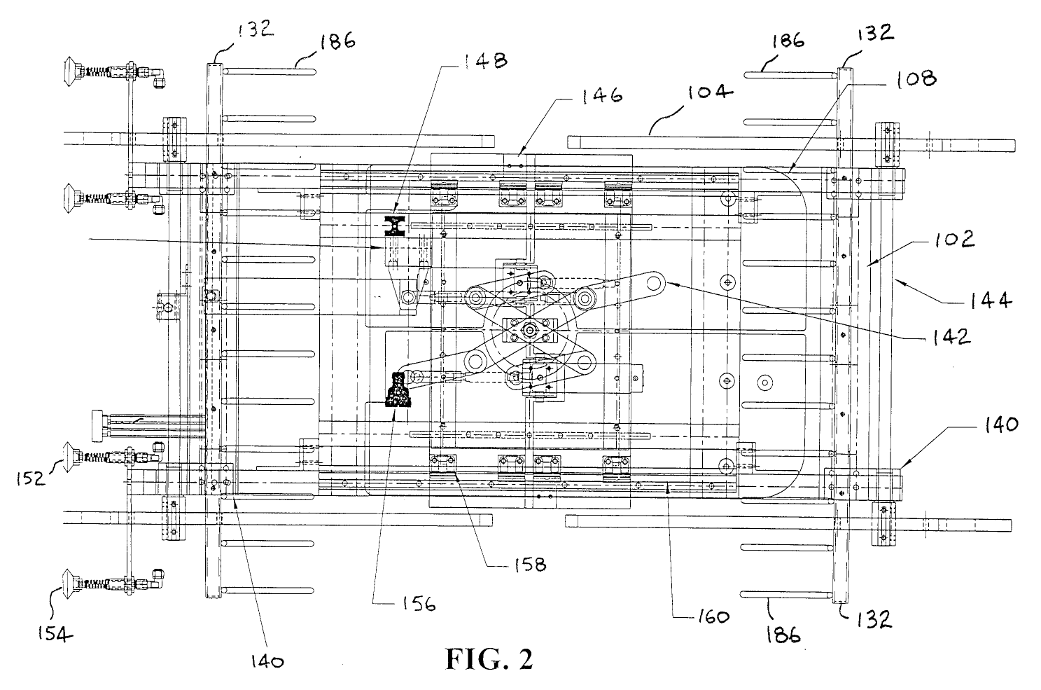

FIG. 2 illustrates the top plan view of the manipulator 100. Each opposing pallet gripper arm 104 is secured to the frame assembly 102 via a pallet arm shaft 144. In the preferred embodiment, the manipulator 100 has two pallet arm shafts 144, one on the left and one on the right side of the frame assembly 102. Each pallet arm shaft 144 is directly attached to the frame 102 via a pallet arm shaft support 140. The linkage subassembly 142 connects the carriage subassembly 121 to the manipulator 100. The linkage subassembly 142 allows the dual opposing carriage plates 128 to move independently of one another. The carriage stop angle block 146 prevents the carriage subassembly 121 from coming too close together in the closed position. The lock washer 148 maintains stability of any cylinder attached to the cylinder mount block 150. For the preferred embodiment, in which pneumatic actuators are used, a Y-connector 156 allows for distribution of air. FIG. 2 also illustrates the suction cup bracket 152 and the extended suction cup bracket 154, the difference being the distance from the center of the frame assembly 102. The top view of the bag gripper subassembly 139 is visible showing its means of attachment to the frame assembly 102. A DRYLIN® brand floating carriage provides lateral movement to any attached wires or pneumatic tubes not shown. The floating carriage 158 glides through an IGUS® brand rail. Both the floating carriage of 158 and the rail 160 are available from Igus Inc., East Providence, R.I.

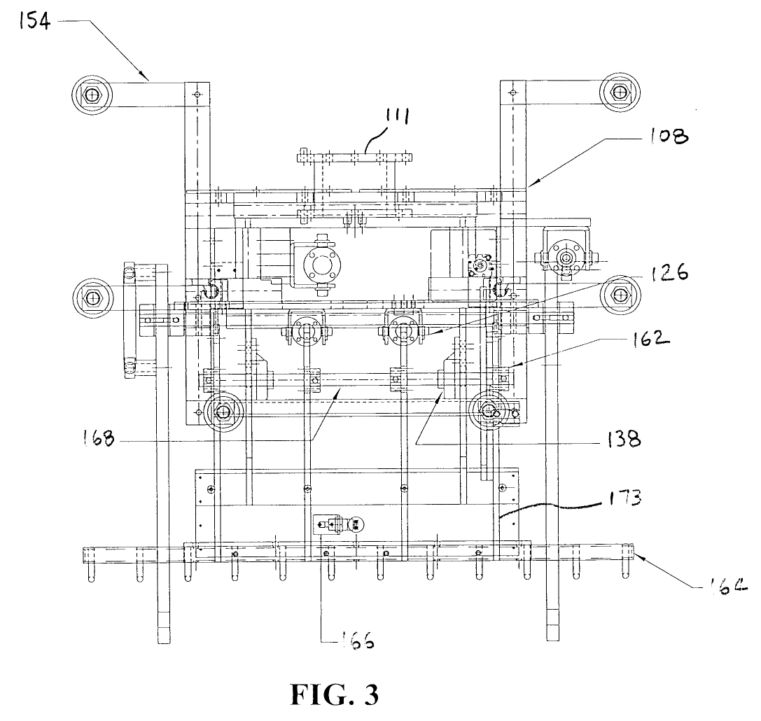

FIG. 3 illustrates the suction subassembly 151 from a side elevation. The manipulator frame cover 108 is positioned at the top of the manipulator 100 for reference. In this preferred embodiment the extended suction cup bracket 154 extends above the manipulator 100 and the manipulator frame cover 108. Also illustrated in FIG. 3 is a side view of the bag gripper subassembly 139. The tine rack weldment 164 is configured with a plurality of tines 186, which as shown in FIG. 3 are aligned substantially parallel with the frame assembly 102. If a proximity indicator is used for the bag gripper subassembly 139, the indicator is attached to the bag gripper prox mount 166. A support shaft 168 is attached to each set of bag gripper arms 173 on each side of the manipulator 100. The support shaft 168 rests in a shaft collar 162 on each bag gripper arm 173.

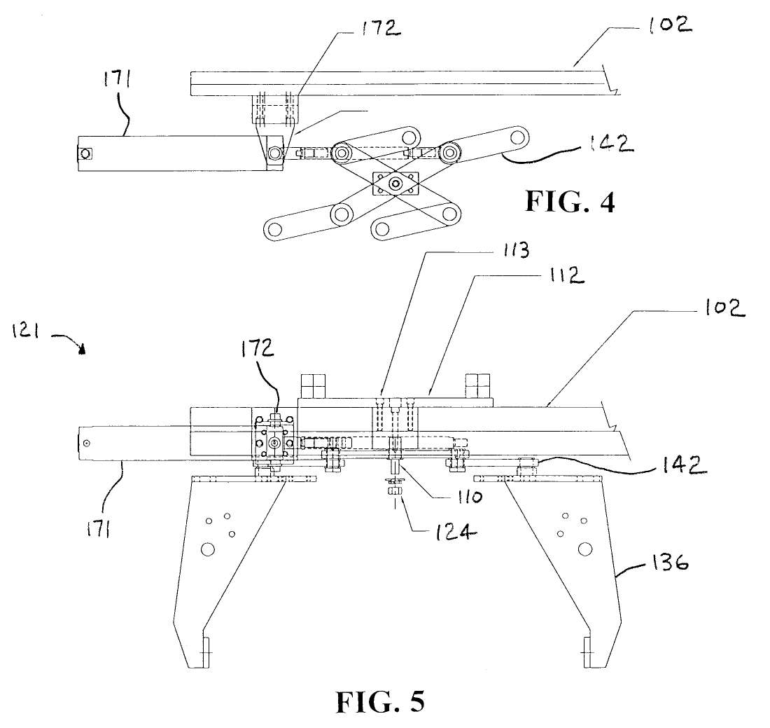

FIG. 4 illustrates a dissected view of the linkage subassembly 142 for the carriage plate subassembly 121. The linkage subassembly 142 is actuated by a trunion mount cylinder 171 preferably operated by pneumatic forces. The trunion mount cylinder 171 is attached to the frame assembly 102 at the trunion mount 170 in the carriage plate cylinder mounting block 172.

FIG. 5 illustrates an elevation view of the carriage subassembly 121 in relation to the linkage subassembly 142. The linkage subassembly 142 is attached to the frame 102 via a linkage rod 124 secured to the linkage center support block 110. The linkage subassembly 142 is positioned relatively below the robot arm of the linkage attachment plate 112 and the linkage attachment bolt 113.

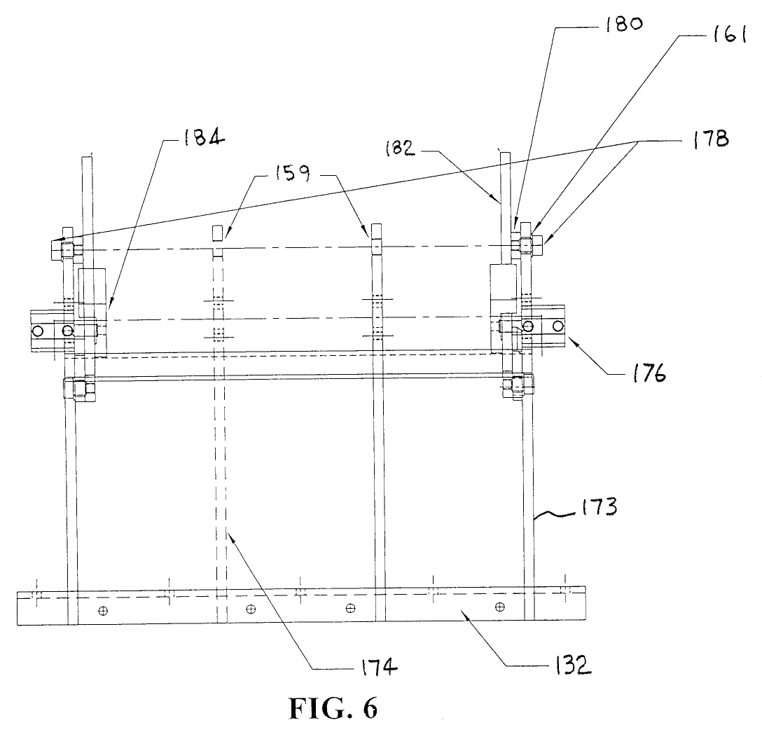

FIG. 6 illustrates the bag gripper subassembly 139 in a side elevation. The bag gripper arms 173 are shown attached to the tine-support weldment 132, shown here in the closed position. An opposing bag gripper arm 174 is also shown. The bag gripper subassembly 139 uses a pancake cylinder 176 connected to a brake clamp 184 to maintain a chose position. When the pancake cylinder 176 is activated, preferably by pneumatic action, the brake clamp 184 creates pressure along the brake slide bar 182 and slows or stops the bag gripper arm 173. The bag gripper arms 173 are secured to the frame assembly 102 via a shoulder bolt attachment 178 fitted with an IGUS® brand sleeve bushing 159 and an IGUS® brand bushing 161. (Igus, Inc., East Providence, R.I.). The brake slide bar 192 is connected to the cylinder 176 via the brake cylinder mount bar 180.

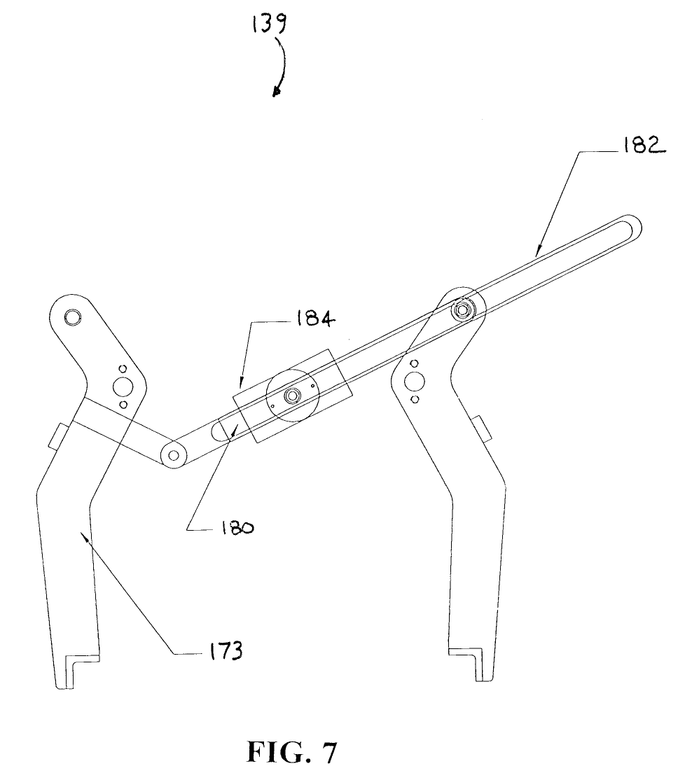

FIG. 7 illustrates a side elevation of the brake system for the bag gripper subassembly 139. The juxtaposition of the brake slide bar 182 relative to the opposing tine-support weldments 132 is illustrated. The brake system including the brake cylinder mount bar 180 and the brake clamp 184 floats between the opposing tine weldments 132.

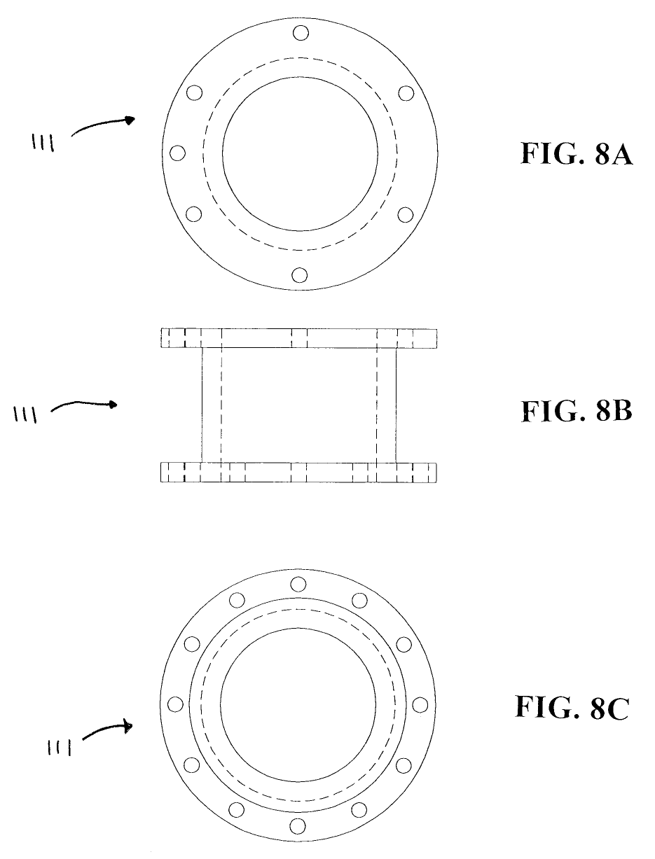

FIG. 8 illustrates the robot arm linkage 111 of the preferred embodiment. Any number if attachment apertures on the top or the bottom of the robot arm linkage could be used.

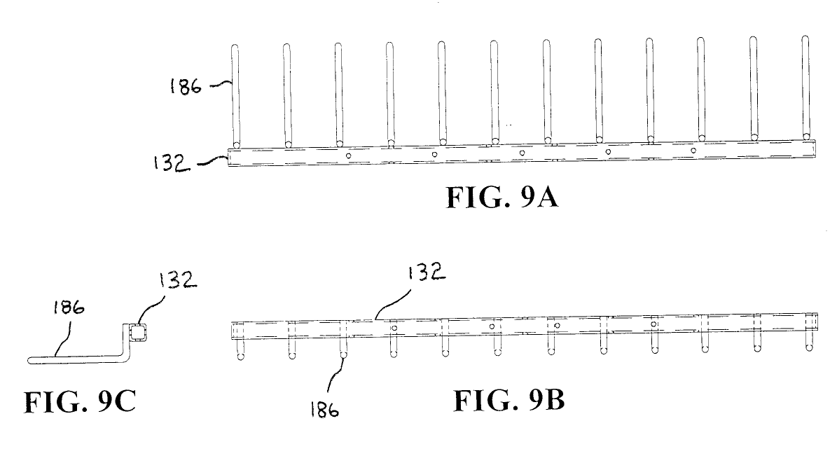

FIG. 9 illustrates the orientation of the plurality of tines 186 using the bag gripper subassembly 139. The individual tines 186 are joined to the tine-support weldment 132, which is then connected to the bag gripper arm 173.

It is understood that the invention is not confined to the particular construction and arrangement of parts herein illustrated and described, but embraces such modified forms thereof as come within the scope of the following claims.

We claim:

1. An apparatus for palletizing a bulk load, comprising:
a frame, comprising a top, a bottom, a front, a rear, a left side, and a right side;
pallet gripping arms opposingly affixed to the frame and dimensioned and configured to reversibly engage a pallet, wherein the pallet gripping arms are movable between a disengaged position, an engaged position, and a stowed position;
an article grasper comprising a pair of opposing grasper arms movably mounted to the bottom of the frame and dimensioned and configured to selectively engage and disengage a bag work piece, wherein the grasper arms are movable between an open and a closed position;
a pressure-sensitive carriage assembly mounted between the opposing grasper arms; and
a suction assembly mounted on a side of the frame, wherein the suction assembly is dimensioned and configured for transporting a sheet work piece.

2. The apparatus of claim 1, wherein the pressure-sensitive carriage assembly comprises first and second horizontal guide plates positioned substantially parallel to one another.

3. The apparatus of claim 2, further comprising opposing pressure-sensitive switches attached to the first and second horizontal guide plates, wherein the pressure-sensitive switches are dimensioned and configured to halt inward motion of the guide plates when the bag work piece is centered between the guide plates.

4. The apparatus of claim 1, wherein the pallet gripping arms are opposingly affixed to the left side and right side of the frame.

5. The apparatus of claim 4, wherein the pallet gripping arms are pivotally movable between the stowed position in which the pallet gripping arms are substantially parallel with the frame, the engaged position in which the pallet gripping arms are substantially perpendicular to the frame and positioned to grasp a pallet, and the disengaged position in which the pallet gripping arms are positioned to release a pallet.

6. The apparatus of claim 4, wherein each of the pallet gripping arms further comprises a gripping portion dimensioned and configured to reversibly engage a pallet.

7. The apparatus of claim 1, further comprising at least one actuator connected to the frame, wherein the actuator is dimensioned and configured to operate the pallet gripping arms, the article grasper, the pressure sensitive carriage assembly, and the suction assembly.

8. The apparatus of claim 7, wherein the at least one actuator is a pneumatic cylinder.

9. The apparatus of claim 7, wherein the at least one actuator is a hydraulic cylinder.

10. The apparatus of claim 1, further comprising an actuator and a corresponding linkage attached to the pallet gripping arms, wherein the linkage is dimensioned and configured to move the pallet gripping arms between the disengaged position, the engaged position, and the stowed position, and further wherein the linkage is dimensioned and configured to move the pallet gripping arms in conjunction with one another.

11. The apparatus of claim 1, further comprising a mounting bracket attached to the frame, wherein the mounting bracket is dimensioned and configured to releasably attach the frame to a robotic arm.

12. The apparatus of claim 1, further comprising a plurality of tines attached to each grasper arm.

13. The apparatus of claim 12, wherein the guide plates are substantially perpendicular to the tines when the grasper arms are in the closed position.

14. The apparatus of claim 1, wherein the plurality of opposing grasper arms, the guide plates, and the pallet gripping arms operate in tandem with one another.

15. The apparatus of claim 1, wherein the plurality of opposing grasper arms are pivotally movable between the first open position and the second closed position.

16. The apparatus of claim 1, wherein each of the plurality of opposing grasper arms is further comprised of:
a support shaft pivotally connected to the frame; and
tines attached to the support shaft.

17. The apparatus of claim 16, wherein each tine is substantially L-shaped.

18. The apparatus of claim 1, wherein the article grasper and the pressure-sensitive carriage assembly operate substantially in conjunction with one another.

19. The apparatus of claim 1, wherein the suction assembly comprises a plurality of pneumatically actuated suction cups.

20. An apparatus for palletizing a bulk load, comprising:
a frame, comprising a top, a bottom, a front, a rear, a left side, and a right side;
pallet gripping arms opposingly affixed to the frame and dimensioned and configured to reversibly engage a pallet, wherein the pallet gripping arms are movable between a disengaged position, an engaged position, and a stowed position, wherein the pallet gripping arms are pivotally movable between the stowed position in which the pallet gripping arms are substantially parallel with the frame, the engaged position in which the pallet gripping arms are substantially perpendicular to the frame and positioned to grasp a pallet, and the disengaged position in which the pallet gripping arms are positioned to release a pallet, and wherein each of the pallet gripping arms further comprises a gripping portion dimensioned and configured to reversibly engage a pallet;
an article grasper comprising a pair of opposing grasper arms movably mounted to the bottom of the frame and dimensioned and configured to selectively engage and disengage a bag work piece, wherein the grasper arms are movable between an open and a closed position;
a pressure-sensitive carriage assembly mounted between the opposing grasper arms, wherein the pressure-sensitive carriage assembly comprises first and second horizontal guide plates positioned substantially parallel to one another, and further comprising opposing pressure-sensitive switches attached to the first and second horizontal guide plates, wherein the pressure-sensitive switches are dimensioned and configured to halt inward motion of the guide plates when the bag work piece is centered between the guide plates; and
a suction assembly mounted on a side of the frame, wherein the suction assembly is dimensioned and configured for transporting a sheet work piece.
